(19) United States
(12) Patent Application Publication
(10) Pub. No.: US 2026/0336738 A1
(43) Pub. Date: Oct. 29, 2026

(54) BICYCLE CARRIER

(71) Applicant: Louis CHUANG, TAICHUNG (TW)

(72) Inventor: Louis CHUANG, TAICHUNG (TW)

(21) Appl. No.: 19/431,655

(22) Filed: Dec. 23, 2025

(30) Foreign Application Priority Data
Apr. 29, 2025 (TW) 114116177

(51) Int. Cl. B62J 7/02

(52) U.S. Cl. CPC B62J 7/02

(57) ABSTRACT

A bicycle carrier includes a rack having a sliding rail and a main body connected to the sliding rail, and a seat post connector having an abutting member connected to one end of the sliding rail. The abutting member has a recessed portion at an end opposite the main body, a side portion on a first side, and a hooking portion on a second side. A swing arm is disposed at the side portion. A fastening strap has one end connected to the hooking portion and an opposite end coupled to a movable receiver slidably engaging the swing arm, the strap passing around the recessed portion. A tightening member is threadedly engaged with the swing arm and abuts against the movable receiver opposite a pivot pin of the swing arm. The bicycle carrier provides easy assembly to bicycle seat posts of varying diameters.

### BACKGROUND OF THE INVENTION

The present invention relates to a cargo rack and, more particularly to a bicycle carrier.

Taiwan Patent No. I721830 discloses a bicycle carrier including a slide block and a sliding member. The sliding member incorporates a sliding portion that is slidably mounted to the slide block. The sliding member is equipped with two stoppers. When the sliding member is fully connected to the slide block, the first stopper is designed to abut the slide block's first end, and the second stopper abuts its second end.

Conventional methods for attaching the bicycle carrier to a seat post typically utilize two clamping blocks that cooperate with a quick-release structure to achieve a clamping and fixing effect. However, the concave arc surfaces of the two clamping blocks can only fit a seat post of a corresponding, specific diameter.

The present invention is therefore intended to obviate or at least alleviate the problems encountered in the prior art.

### SUMMARY OF THE INVENTION

The present invention provides a bicycle carrier having a flexible fastening system for attachment to bicycle seat posts of various diameters. The bicycle carrier comprises a rack, the rack including a main body and a sliding rail. The attachment mechanism utilizes a seat post connector, which comprises an abutting member connected to the sliding rail. The abutting member includes a recessed portion configured to cradle the seat post, a side portion, and a hooking portion. A fastening strap wraps around the seat post. The strap has one end connected to the hooking portion, and the opposite end coupled to a movable receiver slidably engaging a swing arm. A tightening member, threadedly engaged with the swing arm, is configured to abut against the movable receiver to complete the securing operation. This structure enables the bicycle carrier to be tightly fixed to a seat post, regardless of its diameter, through precise and adjustable compression.

Other objectives, advantages, and new features of the present invention will become apparent from the following detailed description of the invention when considered in conjunction with the accompanying drawings.

### BRIEF DESCRIPTION OF DRAWINGS

FIG. 1 is a perspective view of a bicycle carrier according to the present invention.

FIG. 2 is an exploded perspective view of the bicycle carrier of FIG. 1.

FIG. 3 is an exploded perspective view of the bicycle carrier of FI 1 from another angle of view.

FIG. 4 is a cross-sectional view of the bicycle carrier of FIG. 1.

FIG. 5 is a cross-sectional view of a seat post connector of the bicycle carrier of FIG. 1.

FIG. 6 is a cross-sectional view of a seat post connector of the bicycle carrier of FIG. 1, showing a tightening member being screwed tight.

FIG. 7 is a cross-sectional view of a support frame of the bicycle carrier of FIG. 1.

FIG. 8 is a perspective view of a receiving platform coupled to a main body in the second state in the bicycle carrier of FIG. 1.

FIG. 9 is a cross-sectional view of the receiving platform coupled to the main body in the second state in the bicycle carrier of FIG. 1.

### DETAILED DESCRIPTION OF THE INVENTION

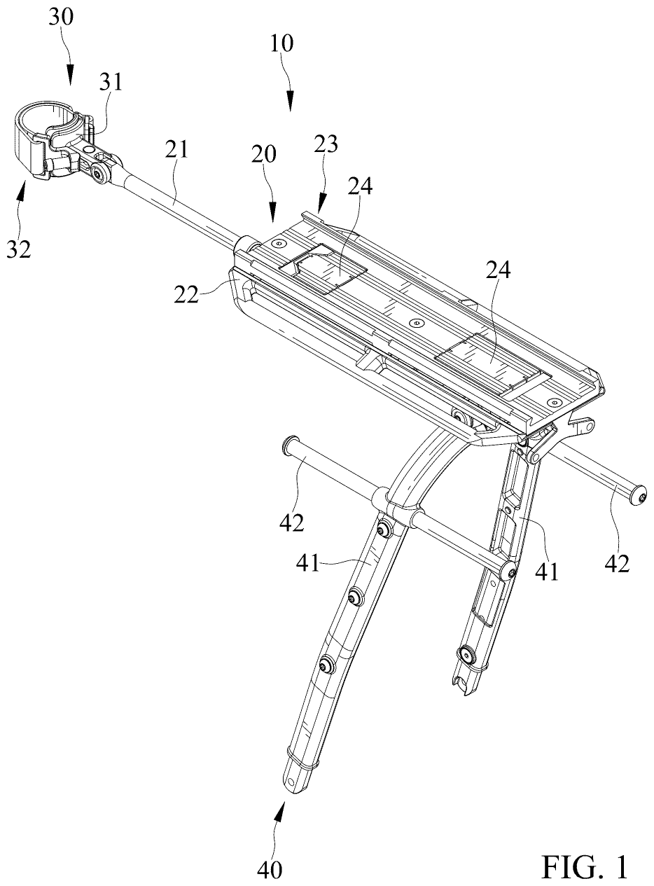

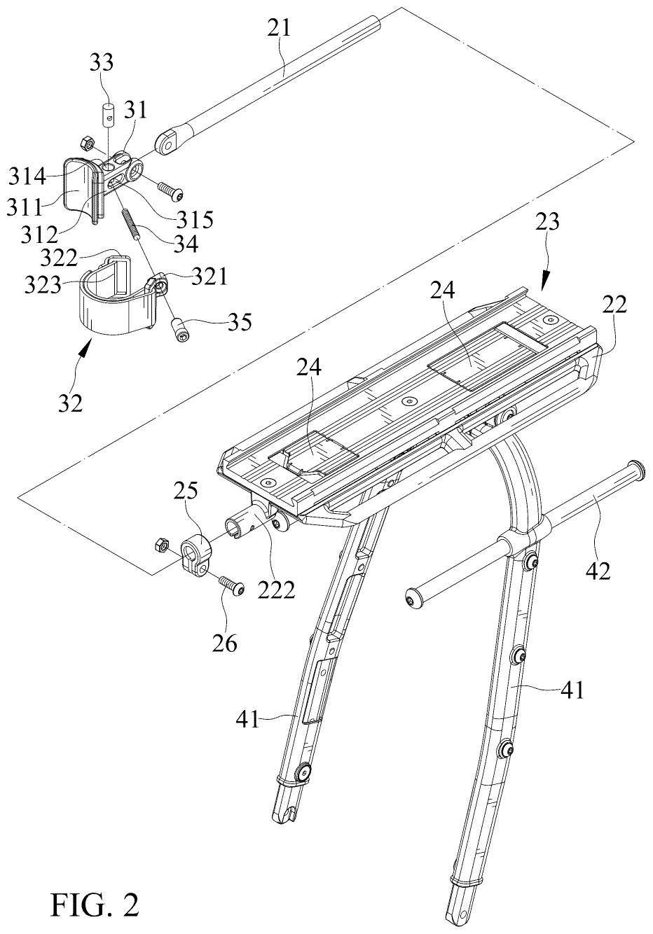

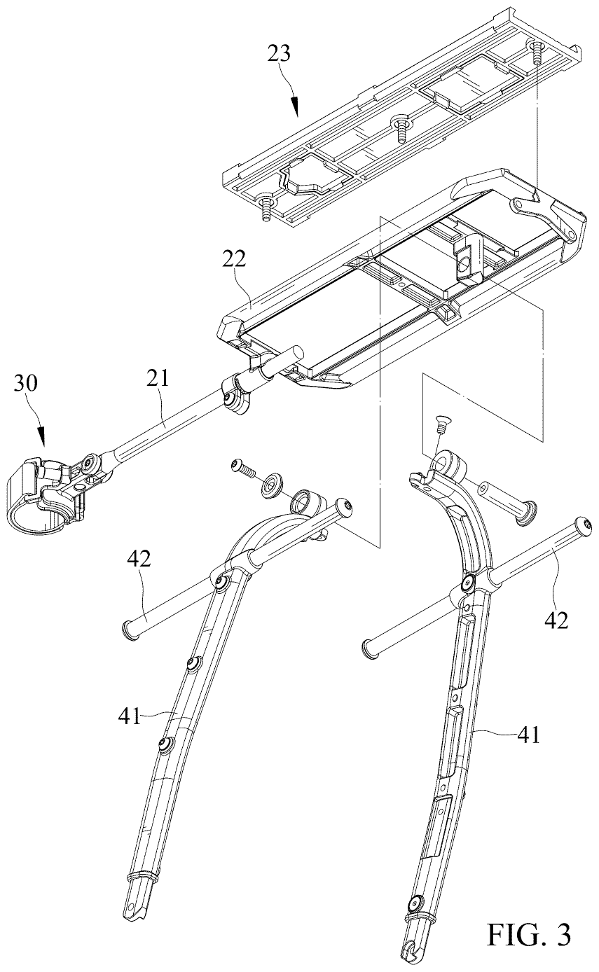

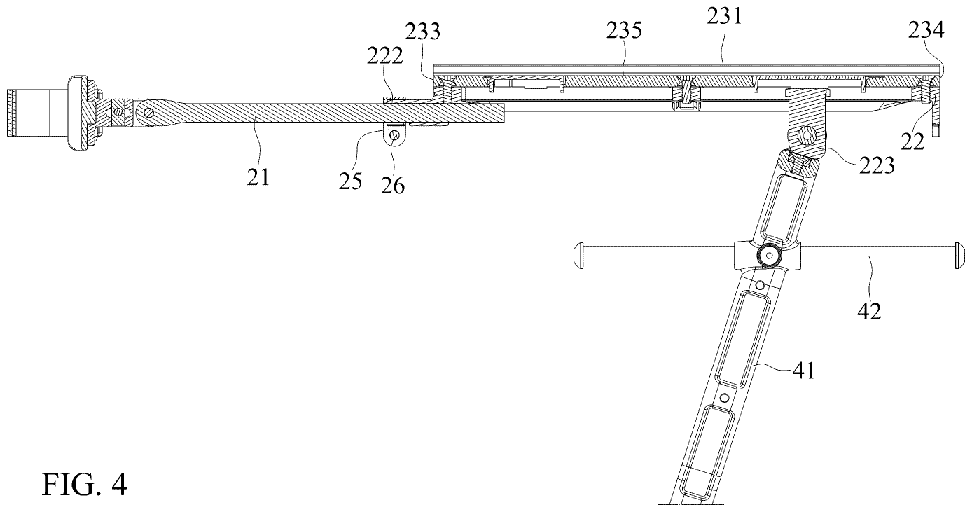

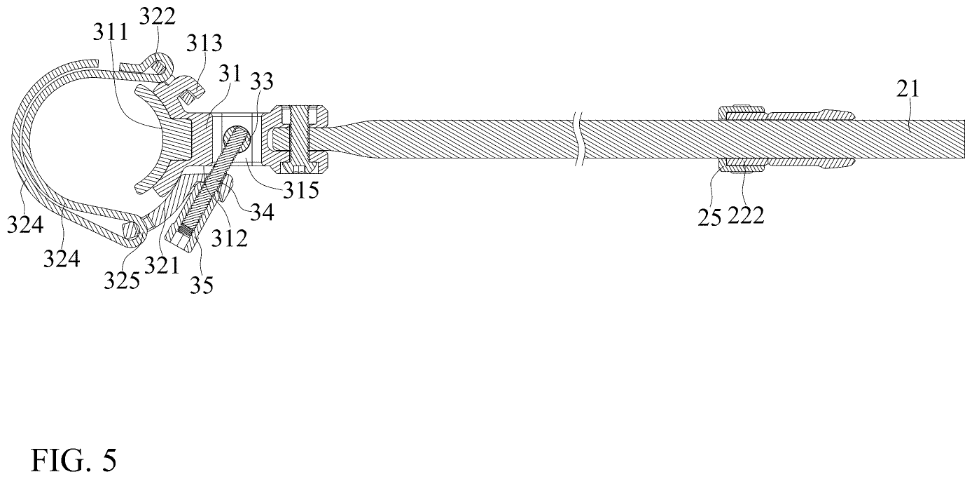

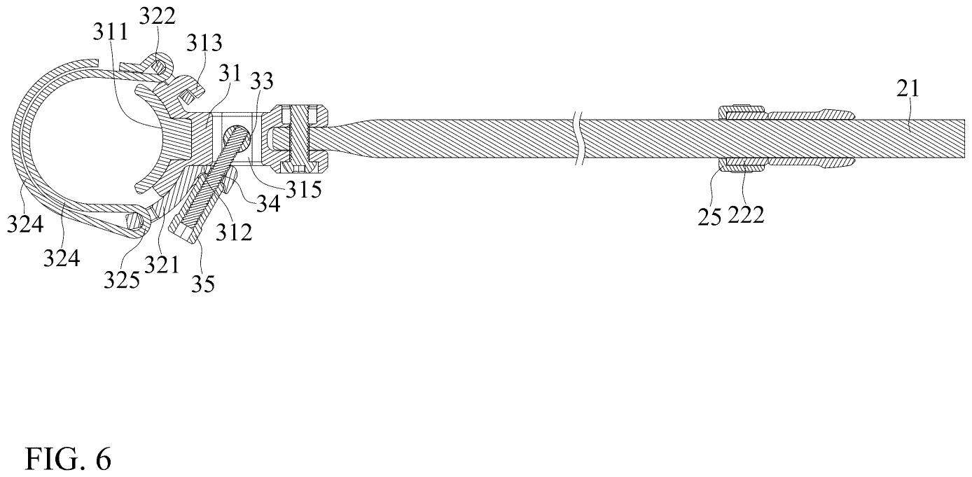

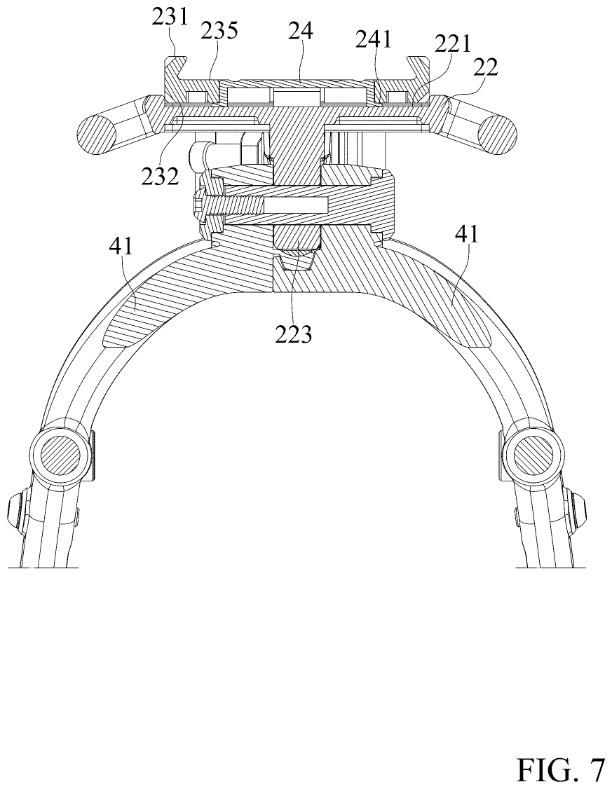

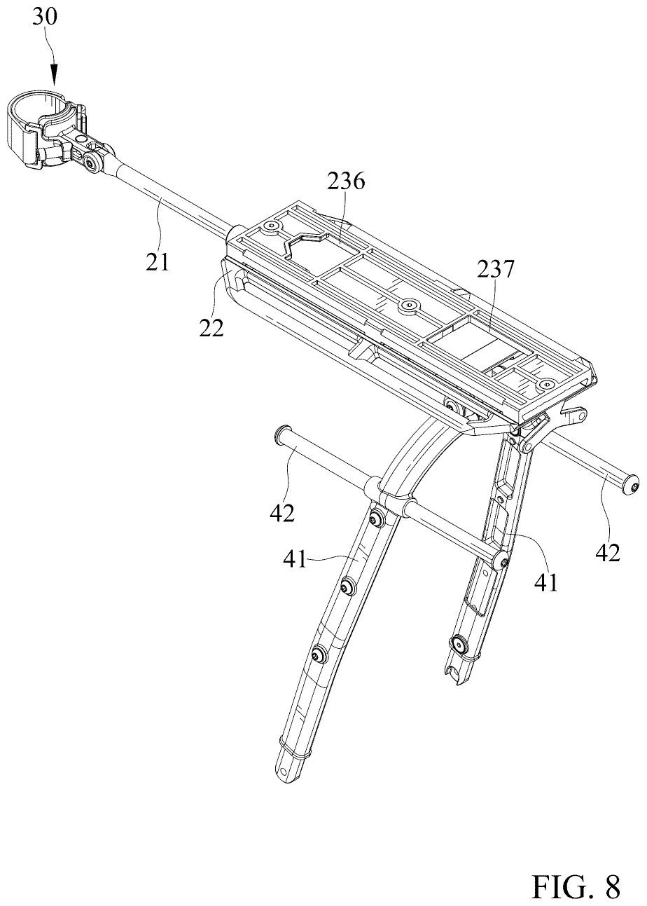

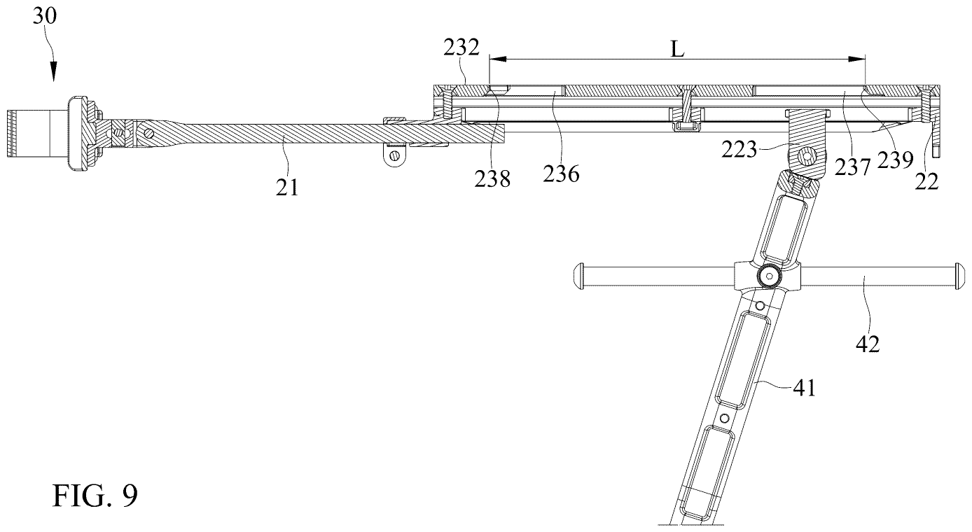

FIGS. 1 to 9 show a bicycle carrier 10 according to the present invention. The bicycle carrier 10 includes a rack 20, a seat post connector 30, and a support frame 40.

The rack 20 includes a sliding rail 21 and a main body 22. The main body 22 is connected to the sliding rail 21.

The seat post connector 30 includes an abutting member 31, a fastening strap 32, a pivot pin 33, a swing arm 34, and a tightening member 35. The abutting member 31 is connected to one end of the sliding rail 21. A recessed portion 311 is disposed at an end of the abutting member 31 opposite to the main body 22. A side portion 312 is disposed on a first side of the abutting member 31 along a horizontal direction, and a hooking portion 313 is disposed on the second side thereof. The abutting member 31 has a pivot bore 314 along a vertical direction and a swing slot 315 in the side portion 312 that communicates with the pivot bore 314. The pivot pin 33 is pivotally disposed in the pivot bore 314. The swing arm 34 is disposed at the side portion 312. One end of the swing arm 34 is rotatably coupled to and secured to the pivot pin 33. The swing arm 34 is pivotally disposed within the swing slot 315. An end of the swing arm 34 opposite to the pivot pin 33 protrudes outside the swing slot 315. One end of the fastening strap 32 has a movable receiver 321, and the movable receiver 321 is sleeved onto the swing arm 34. The fastening strap 32 passes around the recessed portion 311 and has an end opposite to the movable receiver 321 connected to the hooking portion 313. The tightening member 35 is threadedly engaged with the swing arm 34 and abuts against a side of the movable receiver 321 opposite to the end of the swing arm 34 connected to the pivot pin 33.

The fastening strap 32 includes a ring 322 and a strap body 323. The ring 322 is disposed at one end of the fastening strap 32 and is detachably sleeved onto the hooking portion 313. One end of the strap body 323 is connected to the ring 322. The strap body 323 has two fastening portions 324 and a folding portion 325 between the two fastening portions 324. The folding portion 325 passes through the movable receiver 321, and the two fastening portions 324 are attached to each other.

The abutting member 31 is rotatably connected to the sliding rail 21. An inner periphery of the recessed portion 311 is arc-shaped, and the arc shape of the recessed portion 311 is less than a semicircle.

A receiving portion 221 is located on an upper edge of the main body 22 along a vertical direction. The rack 20 includes a receiving platform 23, which is selectively coupled to the main body 22 or detached from the main body 22 in a first state or a second state. The receiving platform 23 includes a first surface 231 and a second surface 232 opposite to the first surface 231. When the receiving platform 23 is coupled to the main body 22 in the first state, the second surface 232 is connected to the receiving portion 221, and the first surface 231 faces a direction opposite to the main body 22. When the receiving platform 23 is coupled to the main body 22 in the second state, the first surface 231 is connected to the receiving portion 221, and the second surface 232 faces a direction opposite to the main body 22. The receiving platform 23 has a first end 233 and a second end 234 opposite to the first end 233. The receiving platform 23 includes a sliding groove 235, a first engaging slot 236, and a second engaging slot 237. The sliding groove 235 is formed on the first surface 231 and extends from the first end 233 to the second end 234. The first engaging slot 236 and the second engaging slot 237 are formed on the second surface 232 and extend through the receiving platform 23 to be connected to the sliding groove 235. The first engaging slot 236 and the second engaging slot 237 are arranged along a direction parallel to the extension of the sliding groove 235.

A first engaging edge 238 is disposed adjacent to the first end 233 of the first engaging slot 236, and a second engaging edge 239 is disposed adjacent to the second end 234 of the second engaging slot 237. A distance between the first engaging edge 238 and the second engaging edge 239 forms an engaging distance L, which is 18 cm or more and 22 cm or less.

The sliding groove 235 is a dovetail groove structure. The rack 20 includes two plugs 24. The two plugs 24 are respectively embedded into the first engaging slot 236 and the second engaging slot 237 from the second surface 232. When the receiving platform 23 is coupled to the main body 22 in the second state, the two plugs 24 can be detached from the first engaging slot 236 and the second engaging slot 237.

A protruding portion 241 is formed on an outer periphery of the two plugs 24. The protruding portion 241 abuts against the second surface 232. When the receiving platform 23 is coupled to the main body 22 in the first state, the protruding portion 241 abuts against the receiving portion 221.

The main body 22 is movably connected to the sliding rail 21. The movement of the main body 22 allows it to approach or move away from the abutting member 31. A tube 222 is disposed on a lower edge of the main body 22 along the vertical direction. The tube 222 is slidably sleeved onto the sliding rail 21. The rack 20 includes a restricting member 25 and a tightening member 26. The restricting member 25 is capable of elastic deformation and is sleeved onto the outside of the tube 222. The tightening member 26 is connected to the restricting member 25 and is capable of compressing the restricting member 25 through a threaded structure.

A pivot portion 223 is disposed on a lower edge of the main body 22 along the vertical direction. The bicycle carrier 10 includes a support frame 40, which includes two support rods 41. The two support rods 41 are respectively pivotally disposed on opposite sides of the pivot portion 223 along the horizontal direction.

The support frame 40 includes two side rods 42. The two side rods 42 are parallel to each other and are respectively inserted into the two support rods 41 along the horizontal direction.

In view of the foregoing, the bicycle carrier 10 is easily assembled to the bicycle seat post through the above structure. When the bicycle carrier 10 is in use, the ring 322 is first detached from the hooking portion 313. The recessed portion 311 is abutted against the seat post, and the strap body 323 is wrapped around the seat post. Then, the ring 322 is re-sleeved onto the hooking portion 313. By adjusting the attachment position of the two fastening portions 324 to change the length of the fastening strap 32, the bicycle carrier 10 can be roughly fixed to the seat post. The user can further screw the tightening member 35 to further tighten the fastening strap 32 by using the threaded structure of the swing arm 34 and the tightening member 35, ensuring that the tension of the fastening strap 32 can tightly fix the bicycle carrier 10 to the seat post.

Although specific embodiments have been illustrated and described, numerous modifications and variations are still possible without departing from the scope of the invention. The scope of the invention is defined by the accompanying claims.

1. A bicycle carrier, comprising:
a rack) including a sliding rail and a main body connected to the sliding rail; and
a seat post connector including an abutting member connected to one end of the sliding rail, the abutting member having a recessed portion at an end thereof opposite to the main body, a side portion disposed on a first side of the abutting member along a horizontal direction, and a hooking portion disposed on a second side thereof along the horizontal direction;
a pivot pin;
a swing arm disposed at the side portion;
a fastening strap, one end of the fastening strap having a movable receiver sleeved onto the swing arm, the fastening strap passing around the recessed portion and having an opposite end connected to the hooking portion; and
a tightening member threadedly engaged with the swing arm and configured to abut against a side of the movable receiver opposite to the end of the swing arm connected to the pivot pin.

2. The bicycle carrier of claim 1, wherein the abutting member defines a pivot bore along a vertical direction and a swing slot in the side portion that communicates with the pivot bore, wherein the pivot pin is pivotally disposed in the pivot bore, the swing arm being rotatably coupled and secured to the pivot pin at one end, and pivotally disposed within the swing slot, and an end of the swing arm opposite to the pivot pin protrudes outside the swing slot.

3. The bicycle carrier of claim 1, wherein the fastening strap includes a ring and a strap body, wherein the ring is located at one end of the fastening strap and is detachably sleeved onto the hooking portion, wherein one end of the strap body is connected to the ring, wherein the strap body has two fastening portions and a folding portion between the two fastening portions, and wherein the folding portion passes through the movable receiver, and the two fastening portions are attached to each other.

4. The bicycle carrier of claim 1, wherein the abutting member is rotatably connected to the sliding rail, and an inner periphery of the recessed portion is arc-shaped, the arc shape of the recessed portion being less than a semicircle.

5. The bicycle carrier of claim 1, wherein a receiving portion is disposed on an upper edge of the main body along a vertical direction, the rack includes a receiving platform, which is capable of being coupled to the main body or detached from the main body in a first state or a second state, the receiving platform has a first surface and a second surface opposite to the first surface; when the receiving platform is coupled to the main body in the first state, the second surface is connected to the receiving portion, and the first surface faces a direction opposite to the main body; when the receiving platform is coupled to the main body in the second state, the first surface is connected to the receiving portion, and the second surface faces a direction opposite to the main body; wherein the receiving platform has a first end and a second end opposite to the first end, and the receiving platform has a sliding groove, a first engaging slot, and a second engaging slot, the sliding groove is disposed on the first surface and extends from the first end to the second end, and the first engaging slot and the second engaging slot are disposed on the second surface and extend through the receiving platform to be connected to the sliding groove, the first engaging slot and the second engaging slot being arranged along a direction parallel to the extension of the sliding groove.

6. The bicycle carrier of claim 5, wherein a first engaging edge is disposed adjacent to the first end of the first engaging slot, and a second engaging edge is disposed adjacent to the second end of the second engaging slot, and a distance between the first engaging edge and the second engaging edge forms an engaging distance, which is 18 cm or more and 22 cm or less.

7. The bicycle carrier of claim 5, wherein the sliding groove is a dovetail groove structure, the rack includes two plugs, the two plugs are respectively embedded into the first engaging slot and the second engaging slot from the second surface, and the two plugs are capable of being detached from the first engaging slot and the second engaging slot when the receiving platform is coupled to the main body in the second state.

8. The bicycle carrier of claim 7, wherein a protruding portion is disposed on an outer periphery of the two plugs, the protruding portion abuts against the second surface, and the protruding portion abuts against the receiving portion when the receiving platform is coupled to the main body in the first state.

9. The bicycle carrier of claim 1, wherein the main body is movably connected to the sliding rail so that the movement of the main body can approach or move away from the abutting member, a tube is disposed on a lower edge of the main body along the vertical direction, the tube is slidably sleeved onto the sliding rail, the rack includes a restricting member and a tightening member, the restricting member is capable of elastic deformation and is sleeved onto the outside of the tube, and the tightening member is connected to the restricting member and is capable of compressing the restricting member through a threaded structure.

10. The bicycle carrier of claim 1, wherein a pivot portion is disposed on a lower edge of the main body along the vertical direction, the carrier includes a support frame, and the support frame includes two support rods, the two support rods being respectively pivotally disposed on opposite sides of the pivot portion along the horizontal direction.

11. The bicycle carrier of claim 10, wherein the support frame includes two side rods, the two side rods being parallel to each other and respectively inserted into the two support rods along the horizontal direction.
